(19) United States
(12) Patent Application Publication
(10) Pub. No.: US 2007/0127446 A1
(43) Pub. Date: Jun. 7, 2007

(54) Telephone exchange apparatus and method for controlling incoming call thereof

(75) Inventor: Kazuhiro Sumi, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/585,143

(22) Filed: Oct. 24, 2006

(30) Foreign Application Priority Data
Oct. 25, 2005 (JP) 2005-310132

(51) Int. Cl. H04L 12/66

(52) U.S. Cl. 370/356

(57) ABSTRACT

According to one embodiment, a telephone exchange apparatus includes a first interface unit which houses a plurality of communication channels and at least one control channel and makes communication connections among a plurality of telephone terminals via the communication channels when incoming calls arrive via the control channel, and a second interface unit which is connected to the first interface and has the same function as that of the first interface, wherein the first interface includes a first controller which transfers the incoming calls to the second interface unit based on predetermined conditions when the incoming calls arrive, and the second interface includes a second controller which makes communication connections among the corresponding plurality of the telephone terminals by using free communication channels based on the incoming calls transferred from the first interface unit.

### CROSS-REFERENCE TO RELATED APPLICATIONS

This application is based upon and claims the benefit of priority from Japanese Patent Application No. 2005-310132, filed Oct. 25, 2005, the entire contents of which are incorporated herein by reference.

### BACKGROUND

1. Field

One embodiment of the invention relates to a telephone exchange apparatus and a method for controlling incoming calls thereof for use in a system performing voice communications among telephone terminals via an Internet protocol (IP) network such as an IP telephone system.

2. Description of the Related Art

In recent years, a network telephone system (IP telephone system) interactively transmitting and receiving in real time images and voices as packet data has started to prevail.

The IP telephone system connects IP telephone terminals to the IP network and connects the IP network to a general telephone network such as an analog telephone line or a public network through a gateway or a master apparatus. The IP telephone system performs protocol conversion, format conversion, and so forth to enable the voice communications inter-IP telephone terminal, and among the IP telephone terminals and the general telephone network.

By the way, in such a system, since the IP telephone terminals and interface units housing them are fixedly associated with one another in the master apparatus, if there is no free voice communication channel in an interface unit to be a call destination, a caller should follow a procedure to perform a reconnection to another IP telephone terminal. Accordingly, much labor and time are required until the caller becomes possible to make a communication with a speaker of an IP telephone terminal to be a connection destination after the caller made a call to the IP telephone terminal of the connection destination.

Therefore, a method for monitoring a state of each interface unit by means of the central control unit of the master apparatus to make a free interface unit receive incoming calls (for example, Jpn. Pat. Appln. KOKAI Publication No. 2003-169079).

However, since the above-mentioned method always monitors states of a plurality of interface units and makes the central control unit execute processing to receive the incoming calls by the free interface unit, the processing burden on the central control unit grows, a processor with a high processing capacity is needed, and then, the master apparatus itself becomes expensive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating a schematic configuration of an IP telephone system regarding a first embodiment of the present invention;

FIG. 2 is an exemplary view for explaining an example of an operation of change-over to a real-time transport protocol (RTP) channel of another IP network interface unit in the first embodiment of the present invention;

FIG. 3 is an exemplary block diagram illustrating a schematic configuration of an IP telephone system regarding a second embodiment of the present invention; and

FIG. 4 is an exemplary view for explaining an example of an operation of change-over to an RTP channel of another IP network interface unit in the second embodiment of the present invention.

### DETAILED DESCRIPTION

Various embodiments according to the invention will be described hereinafter with reference to the accompanying drawings, In general, according to one embodiment of the invention, a telephone exchange apparatus, comprising a first interface unit which houses a plurality of communication channels and at least one control channel and makes communication connections among a plurality of telephone terminals via the communication channels when incoming calls arrive via the control channel; and a second interface unit which is connected to the first interface and has the same function as that of the first interface unit, wherein the first interface unit includes a first controller which transfers the incoming calls to the second interface unit based on predetermined conditions when the incoming calls arrive, and the second interface unit includes a second controller which makes communication connections among the corresponding plurality of the telephone terminals by using free communication channels based on the incoming calls transferred from the first interface unit.

### FIRST EMBODIMENT

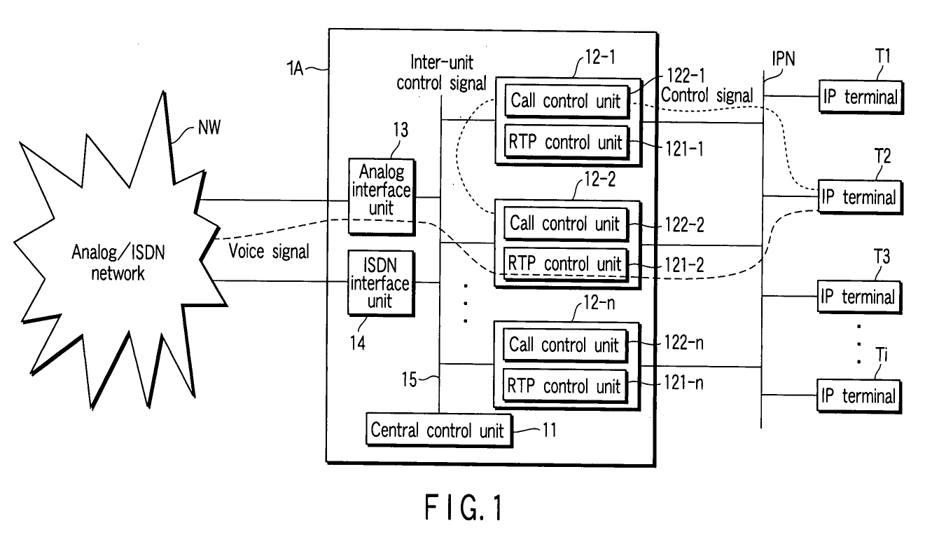

FIG. 1 is a block diagram showing a schematic configuration of an IP telephone system regarding a first embodiment of the present invention.

The IP telephone system is, as shown in FIG. 1, configured to arbitrarily connect an IP network IPN to a master apparatus 1A that is a telephone exchange apparatus. The IP network IPN has a plurality of RTP channels for each IP network interface, control channels of the same number as that of the RTP channels or at least one control channel, and further, connects IP terminals T1 to Ti (i is natural number) as telephone terminals thereto.

The master apparatus 1A further has a central control unit 11, IP network interface units 12-1 to 12-n (n is natural number), an analog interface unit 13 and an ISDN interface unit 14. The central control unit 11, IP network interface units 12-1 to 12-n, analog interface unit 13 and ISDN interface unit 14 are connected to one another via a bus 15.

The central control unit 11 arbitrary switch-interconnects among the IP network interface units 12-1 to 12-n and the analog interface unit 13, among the IP network interface units 12-1 to 12-n and the ISDN interface unit 14, among the analog interface unit 13 and the ISDN interface unit 14, and among the IP network interface units 12-1 to 12-n. The central control unit 11 then controls voice signals/control signals to and from the IP network interface units 12-1 to 12-n, the analog interface unit 13 and the ISDN interface unit 14.

The IP network IPN is connected to the IP network interface units 12-1 to 12-n if necessary. The IP network interface units 12-1 to 12-n perform interface operations related to the connected IP network IPN. The IP network interface units 12-1 to 12-n transmit and receive a variety of items of control information regarding the interface operations to and from the central control unit 11 via the bus 15.

An analog/ISDN network NW is connected to the analog interface unit 13 and the ISDN interface unit 14 as the need arises. The analog interface unit 13 and the ISDN interface unit 14 conduct interface operations related to the connected analog/ISDN network NW. The analog interface unit 13 and the ISDN interface unit 14 transmit and receive a variety of pieces of control information regarding the interface operations to and from the central control unit 11 via the bus 15.

Meanwhile, IP network interface units 12-1 to 12-n have RTP control units 121-1 to 121-n and call control units 122-1 to 122-n, respectively. Hereinafter, the RTP control unit 121-1 and the call control unit 122-1 will be described as each representative thereof.

The RTP control unit 121-1 has, for instance, voice circuits for four channels and converts voice packets into a PCM signal, or converts a PCM signal into voice packets under the control by the call control unit 122-1.

The call control unit 122-1 determines whether or not there is a free voice circuit when an incoming call from the analog/ISDN network NW to the IP terminal T1 arrives thereat as well as transmits and receives a control signal to and from the central control unit 11. If there are not free voice circuits for two (as a reference value of the number) channels, of which the number two is a reference value, the call control unit 122-1 transfers the incoming call to the IP network interface unit 12-2.

In the IP network interface unit 12-2, when receiving the incoming call, the call control unit 122-2 determines whether or not there is a free voice circuit. If there is a free voice circuit in the RTP control unit 121-2, the call control unit 122-2 uses the voice circuit to establish a link with the telephone terminal T1 to be a call destination.

Next to this, an operation in such configuration will be described.

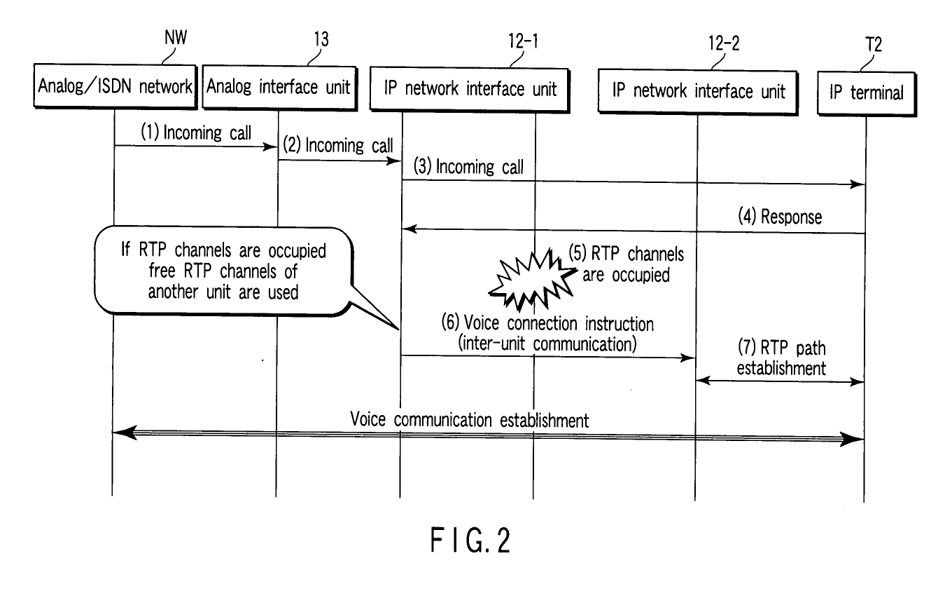

As shown in FIG. 2, it is presumed that the incoming call from the analog/ISDN network NW to the IP terminal T2 arrives at the central control unit 11 via the analog interface unit 13 of the master apparatus 1A ((1) in FIG. 2). The central control unit 11 then transfers the incoming call to the IP network interface unit 12-1 ((2) in FIG. 2).

When receiving the incoming call, the call control unit 122-1 of the IP network interface unit 12-1 calls out the IP terminal T2 of the call destination ((3) in FIG. 2). When the IP terminal 2 responds to this ((4) in FIG. 2), the call control unit 122-1 determines whether or not there is a free voice circuit of the RTP control unit 121-1 ((5) in FIG. 2).

In this situation, since the voice circuits for the two channels of the IP network interface unit 12-1 are not free, the call control unit 122-1 transfers the incoming call to the IP network interface unit 12-2 via the bus 15.

The call control unit 122-2 of the IP network interface unit 12-2 determines whether or not there is a free voice circuit of the RTP control unit 121-2 then in the case of the presence of the free voice circuit, namely, the RTP channel ((6) in FIG. 2), it establishes a communication link using the free RTP channel, namely, an RTP path between the analog/ISDN network NW and the IP terminal T2 ((7) in FIG. 2).

Thus, a voice communication becomes possible between the telephone terminal in the analog/ISDN network NW and the IP terminal T of the call destination.

As described above, in the first embodiment, when the incoming call from the analog/ISDN network NW to the IP terminal T2 arrives at the master apparatus 1A, the call control unit 122-1 of the IP network interface unit 12-1 which has received the incoming call determines whether or not the voice circuits for two channels of the RTP control unit 121-1. Then, in the case of the absence of the free voice circuit, the call control unit 122-1 transfers the incoming call to the IP network interface unit 12-2 not through the central control unit 11. The IP network interface unit 12-2 makes communication connections between the telephone terminal on the analog/ISDN network NW and the IP terminal T2 by using the free RTP channel.

Accordingly, on a caller side, the connection processing to the IP terminal 2 to be the connection destination is automatically conducted only by generating the incoming call, the caller side can be connected to the IP terminal T2 that is the connection destination for a short time, since the processing by the central control unit 11 has not been interposed. The IP telephone system of the first embodiment can reduce the processing burden on the central control unit 11 required to transfer the incoming call and also can reduce operation cost dramatically.

Further, in the IP network interface units 12-1 to 12-n, the RTP channels are set only in case of need, so that the IP telephone system can enhance the effective use rate in the case in which fewer RTP channels are shared by the more IP terminals T1 to Ti than the number of the RTP channels.

In the first embodiment, in the IP network interface unit 12-1, in the case of the presence of the number of occupied RTP channels for the two channels, since the incoming call is transferred to the IP network interface unit 12-2 in spite of the presence of the remaining free RTP channels, the IP telephone system can always save the remaining RTP channels of the IP network interface unit 12-1 for an important communication such as facsimile.

### SECOND EMBODIMENT

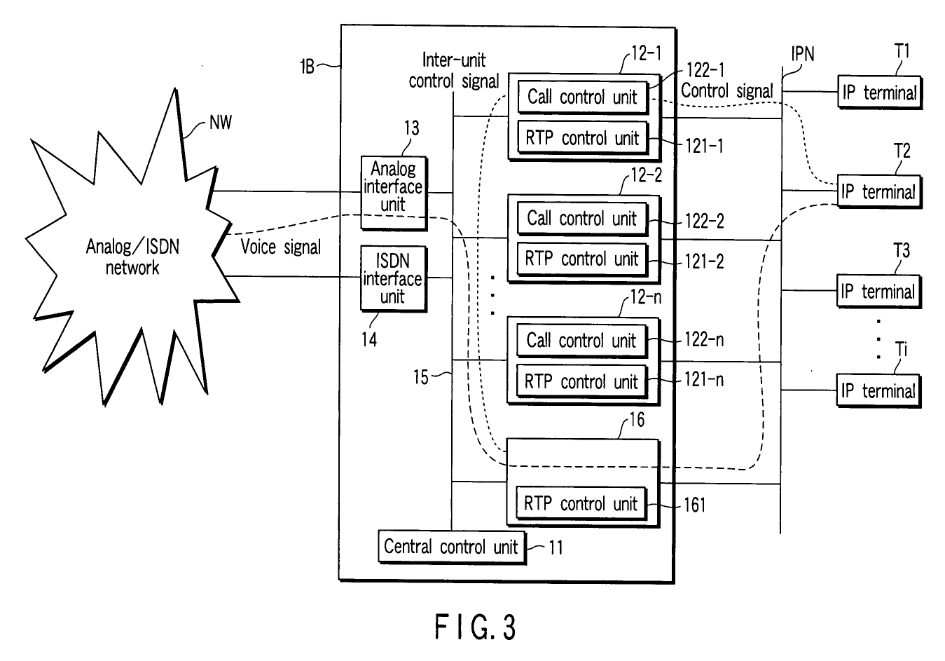

FIG. 3 is a block diagram showing a schematic configuration of an IP telephone system regarding a second embodiment of the present invention. In FIG. 3, identical components to those of FIG. 1 are designated at identical reference symbols and are not described in detail.

In a master apparatus 1B, an IP network interface unit 16 is connected to the bus 15. The IP network interface unit 16 has only an RTP control unit 161 and shares a call control unit with the call control unit 122-1 of the IP network interface unit 12-1.

An operation in such configuration will be described below.

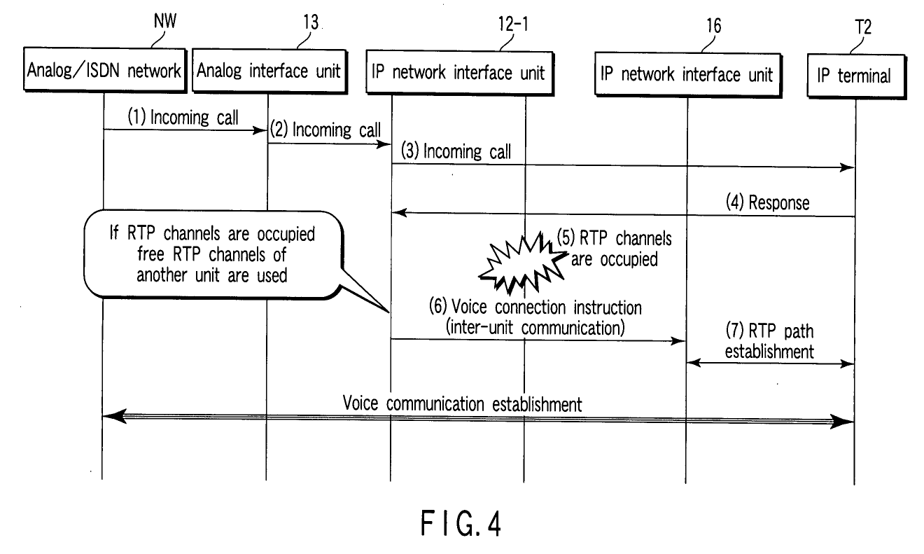

It is supposed that, as shown in FIG. 4, an incoming call from the analog/ISDN network NW from the IP terminal T2 has arrived at the central control unit 11 via the analog interface unit 13 of the master apparatus 1B ((1) in FIG. 4). The central control unit 11 then transfers the incoming call to the IP network interface unit 12-1 ((2) in FIG. 4).

When the incoming call has arrived, the call control unit 122-1 of the IP network interface unit 12-1 calls out the IP terminal T2 to be the call destination ((3) in FIG. 4). If the IP terminal T2 has responded to the calling out ((4) in FIG. 4), the call control unit 122-1 determines whether or not there is any free voice circuit of the RTP control unit 121-1 ((5) in FIG. 4).

In this case, the voice circuits for two channels in the IP interface unit 12-1 having been already occupied, the call control unit 122-1 determines whether or not there is any free voice circuit of the RTP control unit 161 in the IP network interface unit 16. Then, if there is any free voice circuit, namely, an RTP channel ((6) in FIG. 4), the call control unit 122-1 establishes a communication link with the RTP channel used therein, in a word, an RTP path between the analog/ISDN network NW and the IP terminal T2 ((7) in FIG. 4).

Thus, voice communications among the telephone terminals on the analog/ISDN network NW and the IP terminal to be the call destination can be made.

As mentioned above, in the second embodiment, since also the IP network interface unit 16 having only the RTP control unit 161 may be mounted on the master apparatus 1B, costs in a system configuration are also suppressed.

### OTHER EMBODIMENT

The present invention is not limited to the respective foregoing embodiments. For instance, in the respective embodiments, the examples, which use free RTP channels in another IP network interface for the incoming calls in the case of presence of RTP channels of the RTP control units only for two channels, have been described. However, the present invention is not limited to the embodiments, and for example, changing over to use or not to use the RTP channels in another IP network interface unit for each incoming call is possible approach. Further, changing over to use or not to use the RTP channels of another IP network interface unit may be usable so as to make the processing burdens on the respective IP network interfaces equal.

Other than this, types and configurations of the IP telephone systems, configurations of the master apparatus, types of the IP terminals that are telephone terminals, functional configurations of respective interface units, transfer processing procedures of the incoming calls, and the like, may be embodied with a variety of modifications without departing from the concept of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus, comprising a first interface unit which houses a plurality of communication channels and at least one control channel and makes communication connections among a plurality of telephone terminals via the communication channels when incoming calls arrive via the control channel; and a second interface unit which is connected to the first interface and has the same function as that of the first interface unit, wherein
the first interface unit includes a first controller which transfers the incoming calls to the second interface unit based on predetermined conditions when the incoming calls arrive, and
the second interface unit includes a second controller which makes communication connections among the corresponding plurality of the telephone terminals by using free communication channels based on the incoming calls transferred from the first interface unit.

2. The telephone exchange apparatus according to claim 1, wherein the first controller detects whether or not the number of occupied communication channels exceeds a reference value, when the incoming calls arrive, and transfers the incoming calls to the second interface unit, when the number exceeds the reference value.

3. The telephone exchange apparatus according to claim 1, further comprising a third interface unit which is connected to the first interface unit, houses a plurality of communication channels and shares control channel with the control channel of the first interface unit, wherein
the first controller makes communication connections among the corresponding plurality of telephone terminals by using free communication channels of the third interface unit.

4. A method for controlling incoming calls of a telephone exchange apparatus, comprising a first interface unit which houses a plurality of communication channels and at least one control channel and makes communication connections among a plurality of telephone terminals via the communication channels when incoming calls arrive via the control channel; and a second interface unit which is connected to the first interface and has the same function as that of the first interface unit, the method comprising:
transferring the incoming calls to the second interface unit based on predetermined conditions when the incoming calls arrive at the first interface unit; and
making communication connections among the corresponding plurality of telephone terminals by using free communication channels of the second interface unit based on the incoming calls transferred from the first interface unit.
